(19) United States
(12) Patent Application Publication
(10) Pub. No.: US 2026/0351275 A1
(43) Pub. Date: Nov. 5, 2026

(54) LATENCY-OPTIMIZED AI AUDIO PROCESSING

(71) Applicant: Intel Products IP LLC, Santa Clara, CA (US)

(72) Inventors: Przemyslaw Maziewski, Gdansk Pomeranian (PL); Jan Banas, Gdansk (PL); Karol Trzcinski, Zukowo (PL); Sebastian Rosenkiewicz, Gdansk (PL); Piotr Baryczkowski, Czarnkow (PL); Lukasz Kurylo, Gdansk (PL)

(73) Assignee: Intel Products IP LLC, Santa Clara, CA (US)

(21) Appl. No.: 19/721,175

(22) Filed: Jun. 26, 2026

(51) Int. Cl. G10L 21/04; G06N 3/0455; G10L 19/00

(52) U.S. Cl. CPC G10L 21/04; G06N 3/0455; G10L 19/00

(57) ABSTRACT

Systems and methods are provided for latency-optimized artificial intelligence (AI) audio processing. A shared feature encoder converts a time-domain audio signal into feature-domain data for processing by multiple AI models in an audio processing pipeline. The multiple AI models generate feature masks, and mask-processed data is generated based on the feature masks. Each AI model may process the feature-domain data, previously generated mask-processed data, or both to generate a corresponding feature mask. A shared feature decoder converts mask-processed data into processed time-domain audio after processing by the multiple AI models. Expanded audio-frame information including time-domain data, feature-domain data, and feature-mask data may be transmitted between audio processing modules, such as endpoint effect modules, mode effect modules, and copier modules. By sharing feature encoding and feature decoding across the multiple AI models, the pipeline can reduce repeated conversions, latency, compute usage, memory usage, or power consumption.

### TECHNICAL FIELD

This disclosure relates generally to audio processing, and in particular to artificial intelligence audio processing.

### BACKGROUND

Audio processing pipelines in modern computing devices, such as laptops and other portable systems, commonly employ artificial intelligence (AI) models to perform tasks such as echo cancellation, noise reduction, and audio enhancement. These AI-based processing blocks typically receive a time-domain audio signal as input, transform the signal into a feature domain using a feature encoder (e.g., a Short-Time Fourier Transform (STFT)), apply an AI model to generate a feature mask that modifies the input features, and reconstruct the processed signal back to the time domain using a feature decoder (e.g., an Inverse Short-Time Fourier Transform (ISTFT)). In practice, multiple AI processing blocks are often cascaded in a pipeline to address different audio processing tasks. However, the latency introduced by each block (i.e., the “latency adder”) accumulates across the pipeline. For example, a single AI block may introduce a latency adder of approximately 5 to 20 milliseconds, and a pipeline of three cascaded blocks may therefore introduce a cumulative latency of 60 milliseconds or more. The cumulative latency degrades user experience in latency-sensitive applications such as teleconferencing, gaming, and audio recording. Furthermore, the various operations across cascaded blocks consume additional computational resources and power, reducing battery life and overall system efficiency.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1A illustrates an example AI processing block for processing an input signal, such as an audio signal in a personal computing device.

FIG. 1B illustrates an example cascaded AI processing pipeline including multiple AI processing blocks.

FIG. 2 illustrates an example latency-optimized AI processing pipeline, in accordance with various embodiments.

FIG. 3 illustrates an example audio processing architecture, in accordance with various embodiments.

FIG. 4 illustrates an example three-element buffer arrangement for conveying time-domain samples, feature-domain samples, and feature-mask information through an audio processing pipeline, in accordance with various embodiments.

FIG. 5 illustrates an example queue implementation for managing multiple data types in an audio processing pipeline, in accordance with various embodiments.

FIG. 6 illustrates an example modified audio processing architecture, in accordance with various embodiments.

FIG. 7 illustrates an example processing architecture in which a latency-optimized AI processing pipeline is mapped to an endpoint effect and mode effect architecture, in accordance with various embodiments.

FIG. 8 is a flowchart illustrating a method for latency-optimized AI audio processing, in accordance with various embodiments.

FIG. 9 is a block diagram of an example deep learning system, in accordance with various embodiments.

FIG. 10 is a block diagram of an example computing device, in accordance with various embodiments.

### DETAILED DESCRIPTION

### Overview

Systems and methods are provided for a latency-optimized audio processing pipeline architecture in which multiple artificial intelligence (AI) processing blocks share a common feature encoder and a common feature decoder. By eliminating redundant encoding and decoding operations across cascaded AI blocks, the disclosed architecture reduces the cumulative latency adder to that of a single AI processing block, regardless of the number of AI blocks in the pipeline. The architecture further enables each AI model in the pipeline to receive multiple inputs, including original input features, features modified by a preceding AI model, or both, thereby potentially improving processing quality. In some examples, the architecture is implemented in firmware of an audio and context engine (ACE) integrated within a system-on-chip (SoC), wherein a modified buffer structure is transmitted between processing modules to carry time-domain, feature-domain, and mask-domain data.

In conventional audio processing pipelines, each AI-based processing block independently performs feature encoding and decoding. A typical AI processing block receives a time-domain audio signal as input, applies a feature encoder such as a Short-Time Fourier Transform (STFT) to transform the signal into a feature-domain representation, processes the features using an AI model to generate a feature mask, applies the mask to modify the input features, and applies a feature decoder such as an Inverse Short-Time Fourier Transform (iSTFT) to reconstruct the processed signal in the time domain. Multiple such blocks can be cascaded in a pipeline, for example, to perform echo cancellation, noise reduction, and audio enhancement in sequence. However, each block introduces its own latency adder due to the buffering for its encoder and decoder. The cumulative latency across the cascade grows linearly with the number of blocks, resulting in delays that are perceptible and disruptive to real-time audio applications, such as teleconferencing, gaming, and audio recording.

Previous approaches have attempted to address these limitations by consolidating all audio processing tasks into a single, monolithic AI model. In such approaches, a single large model is trained to handle echo cancellation, noise reduction, and other audio processing functions simultaneously, thereby avoiding the need for cascaded blocks and their associated cumulative latency. However, monolithic models suffer from significant practical drawbacks. In particular, monolithic models use excessive computational and memory resources (often on the order of multiple megabytes of RAM), making the models impractical for deployment on resource-constrained platforms such as laptops and portable devices. Moreover, a monolithic model cannot be readily tailored or reconfigured for specific use cases, as the processing tasks are tightly coupled within a single model architecture. The limitations render monolithic approaches unsuitable for flexible, low-power audio processing in modern computing devices.

According to various implementations, an audio processing pipeline architecture is provided that addresses the foregoing limitations by extracting the encoder and decoder from individual AI processing blocks and positioning the encoder and decoder as shared components at the entry and exit points of the pipeline, respectively. In the architecture provided, a single encoder transforms the incoming time-domain audio signal into the feature domain, and a single decoder reconstructs the output signal from the feature domain back to the time domain. The intermediate AI models operate entirely in the feature domain, each receiving feature-domain inputs and producing feature-domain outputs in the form of modified features or feature masks. In some examples, because encoding and decoding are each performed only once, the latency adder of the entire pipeline is reduced to that of a single AI processing block, regardless of the number of AI models in the cascade. Additionally, the shared feature encoder and feature decoder are not limited to any particular transform. In various examples, the encoder and decoder can be a Short-Time Fourier Transform (STFT) and inverse Short-Time Fourier Transform (iSTFT), learned transforms, or filter banks.

In some examples, mask-processed data generated based on a feature mask may include feature-domain data modified by application of the feature mask, an updated feature mask generated based on the feature mask, or another data representation that reflects processing associated with the feature mask. For example, a first feature mask generated by a first AI model may be applied to feature-domain data to produce first modified feature-domain data. In another example, the first feature mask may be used to generate or update mask information without modifying the feature-domain data at that stage of the pipeline. A downstream AI model may then process the feature-domain data, the first modified feature-domain data, the updated mask information, or a combination thereof to generate a subsequent feature mask or subsequent mask-processed data.

In some examples, the shared feature encoder and the shared feature decoder provide a technical improvement to operation of an audio processing system by preventing intermediate AI models from implementing separate reconstruction of time-domain audio and separate re-encoding of the reconstructed time-domain audio. Instead, multiple AI models operate on feature-domain data within a common feature-domain processing pipeline before a processed time-domain audio signal is reconstructed. This arrangement reduces buffering associated with repeated feature encoding and feature decoding, reduces accumulated latency in real-time audio paths, and reduces compute and memory usage associated with maintaining separate encoder and decoder context buffers for individual AI processing blocks.

In some examples, different downstream AI models may use different combinations of feature-domain inputs depending on the audio processing task performed by the downstream AI model. For example, a noise reduction model may process feature-domain data generated by the shared feature encoder to identify noise components before other enhancement operations are applied. An automatic gain control model may process both the original feature-domain data and feature-domain data modified by a preceding noise reduction model to distinguish signal-level changes caused by gain variation from signal-level changes caused by noise suppression. A speech enhancement model may process feature-domain data modified by an echo reduction model to enhance speech components after echo components have been attenuated. In some examples, the selected input combination for each downstream AI model is fixed by a pipeline designer. In other examples, the selected input combination is determined during training by providing multiple available feature-domain inputs to the downstream AI model and allowing trained model parameters to weigh or ignore particular inputs.

Providing multiple feature-domain inputs to a downstream AI model may improve audio processing quality by preserving information that could be lost or attenuated by an upstream mask. For instance, when a downstream AI model receives both original feature-domain data and modified feature-domain data, the downstream AI model can infer whether a spectral component was present in the original input, whether the spectral component was suppressed by an upstream model, and whether the spectral component should influence a downstream enhancement operation. This may reduce artifacts that could occur when downstream processing is based only on a previously modified representation, while still allowing the downstream model to benefit from the upstream processing result.

In some examples, each AI model in the pipeline is configured to receive one or more of a plurality of inputs simultaneously. The inputs may include the original input signal features produced by the shared encoder, features with an applied mask from a preceding AI model in the pipeline, or a combination of the original input signal features and features with an applied mask from a preceding AI model. For example, an automatic gain control model positioned after a denoising model may benefit from receiving both the original unmodified features and the denoised features, enabling the model to understand what the input signal was and how it was modified by the preceding stage. In some examples, the selection of which inputs to provide to each AI model may be predetermined by a pipeline designer. In some examples, the entire pipeline, including multiple AI models, may be trained end-to-end, allowing the AI training process to determine whether additional input information is beneficial for each model. The multi-input flexibility enables the pipeline to be adapted for diverse audio processing scenarios without altering the shared encoder or decoder.

In some examples, the architecture provided herein is implemented within the Audio and Context Engine (ACE) firmware of a SoC. The ACE firmware architecture reflects the structure of the operating system audio framework and provides two processing containers for hosting AI audio models: an end-point effect (EFX) container, which hosts processing algorithms that apply to the audio streams (also called pins) visible to the operating system, and a mode effect (MFX) container, which hosts algorithms for selected individual audio streams, allowing stream-specific processing to differ on a per-use-case basis. The processing branches connect to a Direct Memory Access (DMA) copier module that transmits processed data to the operating system.

To enable the latency-optimized pipeline within the ACE architecture, a modified buffer structure is provided for transmissions between the EFX, MFX, and copier modules. The modified buffer includes three elements: time-domain PCM samples (T), feature-domain samples (F), and feature-mask data (FMask). As used herein, feature-mask data may include one or more masks generated by one or more AI models for modifying corresponding feature-domain samples. The inclusion of the time-domain samples in the three-element buffer maintains backward compatibility with the legacy architecture. In some examples, employing an STFT with 50% overlap, the buffer includes pairs of feature and mask representations for even and odd numbered frames, and naturally extends to other overlap configurations. In some examples, the specific structure of the three-element buffer may vary depending on the type of encoder used. The STFT-based buffer structure is one example. Other encoders may produce different buffer configurations. A possible implementation of the modified buffer structure includes a queue in which each element includes pointers to consecutive in-memory representations of each of the three data types of elements (time-domain PCM samples, feature-domain samples, and time-feature masks).

In some examples, the copier module is configured to transmit only the time-domain component of the three-element buffer to the operating system, while the feature-domain and mask components remain internal to the pipeline for use by downstream processing modules. In other examples, the feature decoder is omitted from the firmware pipeline, and all three elements of the buffer (i.e., the time-domain samples, feature-domain samples, and feature masks) are transmitted to the operating system. In some examples, additional AI processing may be performed at the operating system level using the feature-domain data, and the feature decoder may be positioned at the operating system level to reconstruct the time-domain signal after operating system-level processing is complete. In some examples, the alternative configuration extends the benefits of the shared-encoder pipeline architecture beyond the firmware layer.

According to various implementations, the architecture provides substantial compute and memory savings in addition to latency reduction. Although the three-element buffer is larger than the legacy time-domain-only buffer, the elimination of redundant encoders and decoders across multiple AI blocks yields a net reduction in memory consumption. In particular, each removed encoder and decoder included its own separate memory budget for context buffers used in signal reconstruction. The memory savings from removing these per-module context buffers exceed the additional memory used for the three-element buffer. For example, in a configuration with four microphones and four loudspeakers operating at a 96 kHz sampling rate, the architecture yields compute savings of approximately 160 million cycles per second (MCPS) and net memory savings that scale with the number of modules in the pipeline. Furthermore, because the shared encoder and decoder may be standardized within the firmware environment, software developers can design audio processing algorithms to conform to the standardized interface when porting to the ACE firmware, thereby enabling flexible deployment of small, single-responsibility AI processing modules with reduced development effort.

For purposes of explanation, specific numbers, materials, and configurations are set forth in order to provide a thorough understanding of the illustrative implementations. However, it will be apparent to one skilled in the art that the present disclosure may be practiced without the specific details or that the present disclosure may be practiced with only some of the described aspects. In other instances, well-known features are omitted or simplified in order not to obscure the illustrative implementations.

Further, references are made to the accompanying drawings that form a part hereof, and in which is shown, by way of illustration, embodiments that may be practiced. It is to be understood that other embodiments may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the claimed subject matter. However, the order of description should not be construed as implying that these operations are necessarily order dependent. In particular, these operations may not be performed in the order of presentation. Operations described may be performed in a different order from the described embodiment. Various additional operations may be performed or described operations may be omitted in additional embodiments.

For the purposes of the present disclosure, the phrase “A and/or B” or the phrase “A or B” means (A), (B), or (A and B). For the purposes of the present disclosure, the phrase “A, B, and/or C” or the phrase “A, B, or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the following detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/−20% of a target value based on the input operand of a particular value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value based on the input operand of a particular value as described herein or as known in the art.

In addition, the terms “comprise,” “comprising,” “include,” “including,” “have,” “having” or any other variation thereof, are intended to cover a non-exclusive inclusion. For example, a method, process, device, or system that comprises a list of elements is not necessarily limited to only those elements but may include other elements not expressly listed or inherent to such method, process, device, or system. Also, the term “or” refers to an inclusive “or” and not to an exclusive “or.”

The systems, methods, and devices of this disclosure each have several innovative aspects, no single one of which is solely responsible for all desirable attributes disclosed herein. Details of one or more implementations of the subject matter described in this specification are set forth in the description below and the accompanying drawings.

### Example Systems for AI Audio Processing

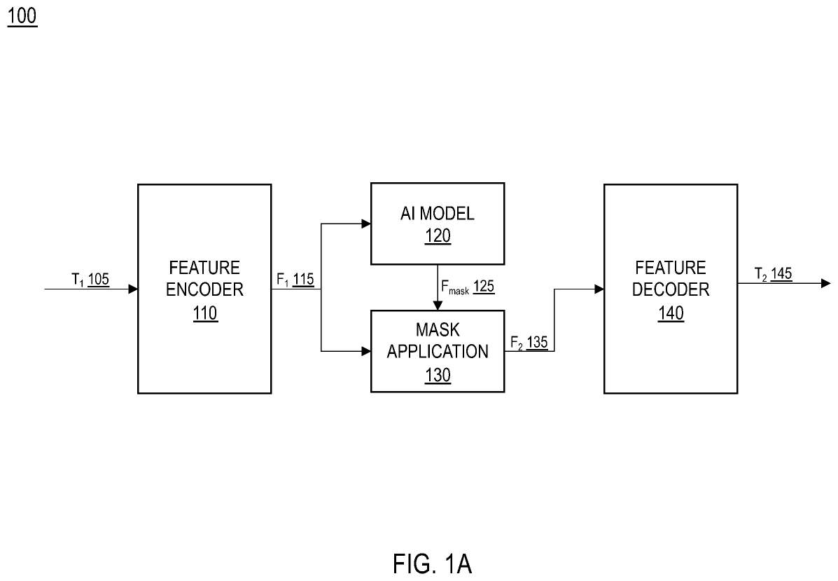

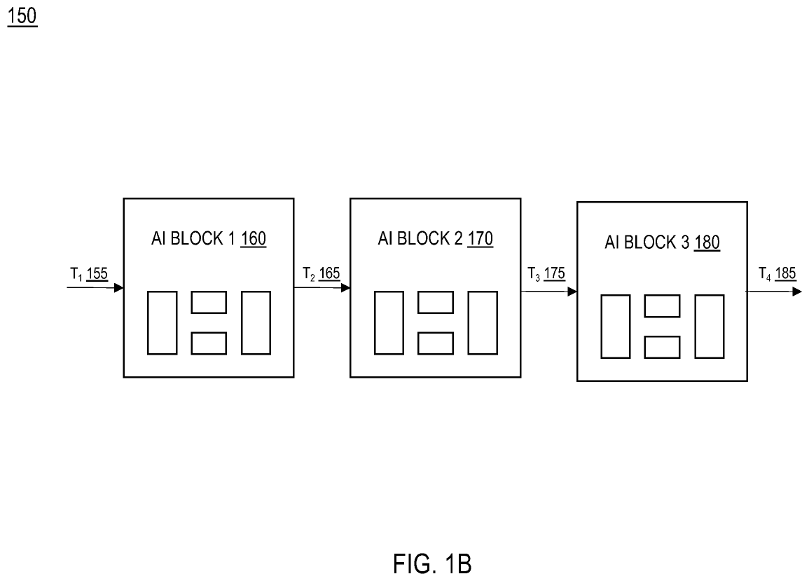

FIG. 1A illustrates an example AI processing block 100 for processing an input signal, such as an audio signal in a personal computing device. The AI processing block 100 receives a time-domain input signal T1 105 at a feature encoder 110. The feature encoder 110 converts the time-domain input signal T1 105 into feature-domain data F1 115. In some examples, the feature encoder 110 may perform a short-time Fourier transform (STFT), a learned transform, a filter-bank transform, or another suitable time-to-feature conversion.

The feature-domain data F1 115 is provided to an AI model 120 and to a mask application block 130. The AI model 120 processes the feature-domain data F1 115 to generate a feature mask Fmask 125. The mask application block 130 applies the feature mask Fmask 125 to the feature-domain data F1 115 to produce modified feature-domain data F2 135. For example, the feature mask Fmask 125 may suppress noise, reduce echo, adjust gain, enhance speech, or otherwise modify selected portions of the feature-domain representation.

The modified feature-domain data F2 135 is provided to a feature decoder 140, which converts the modified feature-domain data F2 135 back into a time-domain output signal T2 145. In some examples, the feature decoder 140 may perform an inverse short-time Fourier transform (iSTFT) or another selected feature-to-time conversion corresponding to the feature encoder 110. The feature encoder 110 and feature decoder 140 may use buffering, overlap-add processing, or other reconstruction operations that introduce a latency adder into the AI processing block 100.

FIG. 1B illustrates an example cascaded AI processing pipeline 150 including multiple AI processing blocks 160, 170, and 180. In various examples, each of the AI processing blocks 160, 170, 180 includes the components of the AI processing block 100 of FIG. 1A. A time-domain input signal T1 155 is processed by a first AI processing block 160 to generate a time-domain signal T2 165. The signal T2 165 is then processed by a second AI processing block 170 to generate a time-domain signal T3 175, and the signal T3 175 is processed by a third AI processing block 180 to generate a time-domain output signal T4 185. Each of the AI processing blocks 160, 170, and 180 may correspond to the AI processing block 100 of FIG. 1A and may perform a different audio processing function, such as echo cancellation, noise reduction, automatic gain control, or speech enhancement.

In various examples, because each AI processing block 160, 170, and 180 includes its own feature encoder and feature decoder, the latency added by the feature encoding and decoding operations can accumulate across the cascaded AI processing pipeline 150. Thus, when multiple AI processing blocks (e.g., blocks 160, 170, 180) are serially connected, the total latency may increase approximately with the number of blocks in the pipeline. The accumulated latency can degrade real-time audio applications, including teleconferencing, gaming, and audio recording, by increasing the delay between speech capture and speech output.

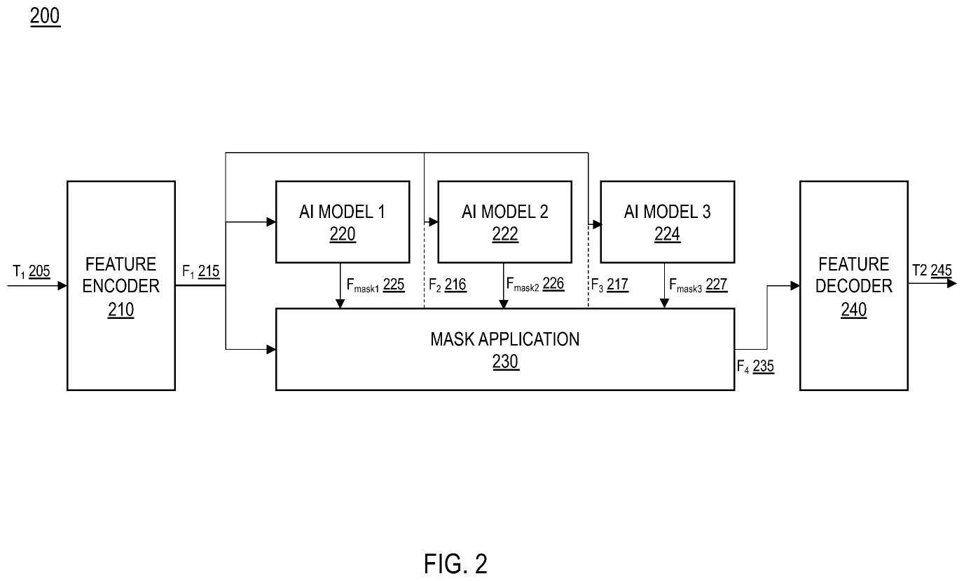

FIG. 2 illustrates an example latency-optimized AI processing pipeline 200, in accordance with various embodiments. In some examples, the AI processing pipeline 200 may be used to process an input signal, such as an audio signal captured by one or more microphones of a computing device. The AI processing pipeline 200 may include a feature encoder 210, a plurality of AI models 220, 222, and 224, a mask application block 230, and a feature decoder 240.

In some examples, the feature encoder 210 receives a time-domain input signal T1 205. The time-domain input signal T1 205 may include audio samples, such as pulse-code modulation (PCM) samples, although other time-domain signal formats may be used. The feature encoder 210 converts the time-domain input signal T1 205 into feature-domain data F1 215. For example, the feature encoder 210 may perform a short-time Fourier transform (STFT), a filter-bank transform, a learned transform, or another suitable time-to-feature conversion.

The feature-domain data F1 215 may be provided to the AI model 1 220. The AI model 1 220 may process the feature-domain data F1 215 to generate a first feature mask Fmask1 225. In some examples, the first feature mask Fmask1 225 may correspond to a modification to be applied to the feature-domain data F1 215, such as a noise suppression mask, an echo reduction mask, a speech enhancement mask, an automatic gain control mask, or another feature-domain modification.

The first feature mask Fmask1 225 may be provided to the mask application block 230. The mask application block 230 may apply the first feature mask Fmask1 225 to the feature-domain data F1 215 to produce modified feature-domain data F2 216. The modified feature-domain data F2 216 may represent the feature-domain data F1 215 after a first AI-based processing operation has been applied.

In some examples, the AI model 2 222 may receive the feature-domain data F1 215, the modified feature-domain data F2 216, or both. The selection of inputs to the AI model 2 222 may be predetermined by a pipeline designer, selected based on training of the AI processing pipeline 200, or otherwise configured for a particular use case. The AI model 2 222 may generate a second feature mask Fmask2 226 based on the received input data.

In one example, the AI model 2 222 receives both the feature-domain data F1 215 and the modified feature-domain data F2 216 when the AI model 2 222 performs gain control after a noise reduction operation. Providing both inputs allows the AI model 2 222 to evaluate a relationship between the original spectral content of the time-domain input signal and spectral content remaining after noise reduction. In another example, the AI model 2 222 receives only the modified feature-domain data F2 216 when the processing function of the AI model 2 222 is intended to operate only on an already-denoised or already-echo-reduced representation.

The second feature mask Fmask2 226 may be provided to the mask application block 230. The mask application block 230 may apply the second feature mask Fmask2 226 to feature-domain data to generate modified feature-domain data F3 217. In some examples, the AI model 2 222 may perform a processing function different from the AI model 1 220. For example, one of the AI models 220 and 222 may perform echo reduction, while another of the AI models 220 and 222 may perform noise reduction, gain control, dereverberation, or another audio enhancement operation.

In some examples, the AI model 3 224 may receive one or more of the feature-domain data F1 215, the modified feature-domain data F2 216, and the modified feature-domain data F3 217. The AI model 3 224 may generate a third feature mask Fmask3 227, which may be applied by the mask application block 230 to produce further modified feature-domain data F4 235. Thus, the AI models 220, 222, and 224 may operate in a common feature domain while generating respective masks for sequential or otherwise coordinated feature-domain processing.

The mask application block 230 may combine or sequentially apply the feature masks Fmask1 225, Fmask2 226, and Fmask3 227 to generate the modified feature-domain data F4 235. In some examples, the masks may be applied in a predetermined order corresponding to a selected audio processing sequence. For example, echo reduction may be performed before noise suppression, and noise suppression may be performed before gain control. In other examples, the order of the AI models 220, 222, and 224 may be varied without departing from the operation of the AI processing pipeline 200.

In some examples, rather than applying each generated feature mask to the feature-domain data immediately after the feature mask is generated, the mask application block 230 may update mask information through the sequence of AI models 220, 222, and 224. For instance, the first feature mask Fmask1 225 may be used to generate first mask-processed data in the form of an updated feature mask, and the second feature mask Fmask2 226 may be used to further update the updated feature mask to generate second mask-processed data. In such examples, a mask from a given AI model may not be associated with modification of feature-domain data at the corresponding stage of the sequence. Instead, the mask from the given AI model may be associated with updating a previous mask or other mask information. After generation of masks by the plurality of AI models, a last updated feature mask may be applied to the feature-domain data to generate modified feature-domain data for conversion by the shared feature decoder 240. In some examples, applying only the last updated feature mask at the end of the model sequence may reduce a number of multiplication operations performed by the audio processing pipeline.

The modified feature-domain data F4 235 may be provided to the feature decoder 240. The feature decoder 240 may convert the modified feature-domain data F4 235 into a time-domain output signal T2 245. In some examples, the feature decoder 240 may perform an inverse short-time Fourier transform (iSTFT), an inverse filter-bank transform, an inverse learned transform, or another feature-to-time conversion corresponding to the conversion performed by the feature encoder 210.

By using the shared feature encoder 210 and the shared feature decoder 240 for multiple AI models 220, 222, and 224, the AI processing pipeline 200 may reduce latency relative to a cascaded arrangement in which each AI model is included in a separate AI processing block having its own encoder and decoder. In some examples, the latency associated with feature encoding and feature decoding may be incurred once for the AI processing pipeline 200 rather than being incurred separately for each of the AI models 220, 222, and 224. The AI processing pipeline 200 may thereby reduce delay, compute usage, memory usage, and power consumption in real-time signal processing applications.

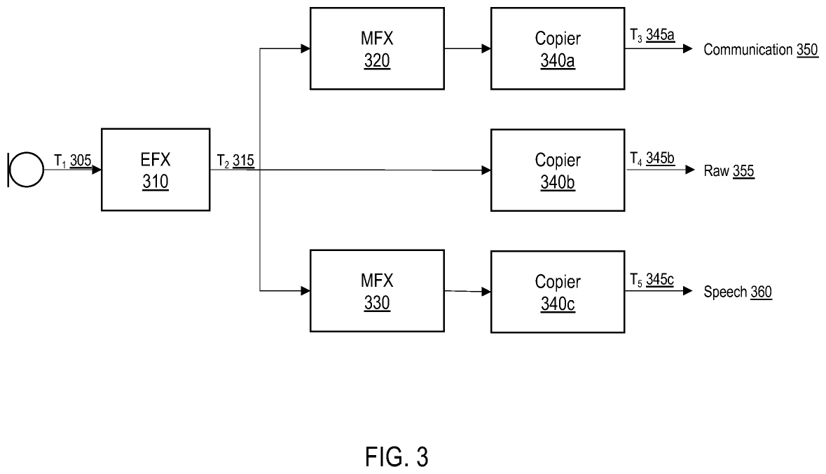

FIG. 3 illustrates an example audio processing architecture 300, in accordance with various embodiments. In some examples, the audio processing architecture 300 may be implemented in audio firmware, such as firmware of a system-on-chip, to process one or more microphone input streams before the processed streams are made available to an operating system or to one or more applications. The audio processing architecture 300 receives a time-domain input signal T1 305 at an endpoint effect block EFX 310.

In some examples, the EFX 310 performs processing that is applied to multiple output streams or pins of the audio processing architecture 300. The EFX 310 outputs a time-domain signal T2 315 that may be provided to one or more downstream branches. A first branch may include a mode effect block MFX 320, a copier 340a, and an output time-domain signal T3 345a corresponding to a communication output 350. A second branch may include a copier 340b and an output time-domain signal T4 345b corresponding to a raw output 355. A third branch may include a mode effect block MFX 330, a copier 340c, and an output time-domain signal T5 345c corresponding to a speech output 360.

In some examples, the MFX 320 and the MFX 330 may perform stream-specific processing for respective output streams. For instance, the MFX 320 may perform processing for the communication output 350, while the MFX 330 may perform processing for the speech output 360. The raw output 355 may bypass one or more of the MFX 320 and the MFX 330 and may be provided through the copier 340b. The copiers 340a, 340b, and 340c may transfer the respective time-domain signals T3 345a, T4 345b, and T5 345c to corresponding system pins or other output destinations.

In some examples, the audio processing architecture 300 may represent a legacy arrangement in which data transmitted between the EFX 310, the MFX 320, the MFX 330, and the copiers 340a, 340b, and 340c includes time-domain data. In some examples, when AI-based audio processing is implemented in more than one of the EFX 310, the MFX 320, and the MFX 330, each AI-based processing block may include its own feature encoder and feature decoder. Accordingly, latency introduced by feature encoding and feature decoding may be accumulated across multiple blocks, such as where a signal path passes through both the EFX 310 and one of the MFX 320 or the MFX 330 before reaching a corresponding output.

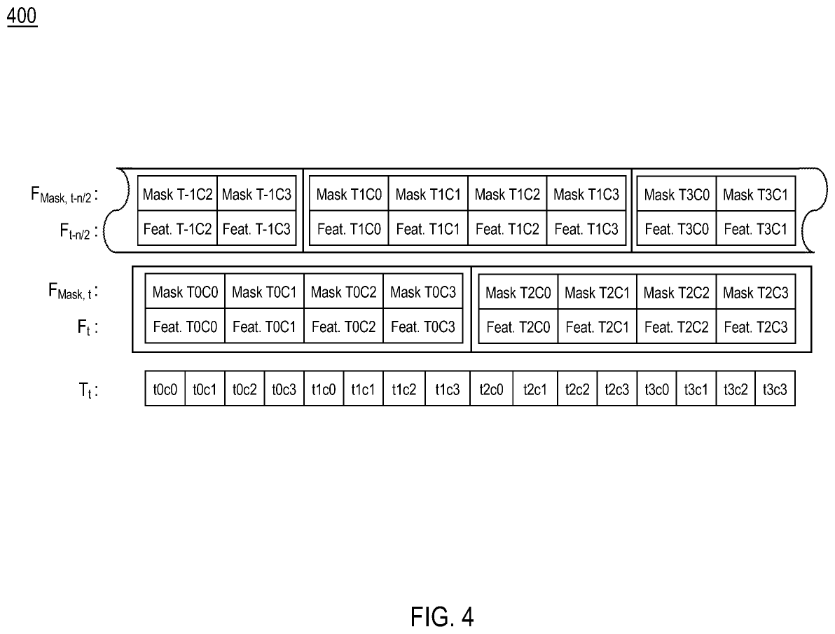

FIG. 4 illustrates an example three-element buffer arrangement 400 for conveying time-domain samples, feature-domain samples, and feature-mask information through an audio processing pipeline, in accordance with various embodiments. In some examples, the three-element buffer arrangement 400 may be used to support an architecture in which multiple AI models share feature-domain data rather than each AI model separately encoding and decoding time-domain data. The three-element buffer arrangement 400 may include a time-domain portion Tt, a current feature-domain portion Ft, a current mask portion FMask, t, an offset feature-domain portion Ft-n/2, and an offset mask portion FMask, t-n/2.

In some examples, the time-domain portion Tt of the three-element buffer arrangement 400 may include time-domain samples arranged according to time index and channel index. For instance, the illustrated time-domain portion Tt includes samples t0c0, t0c1, t0c2, t0c3, t1c0, t1c1, t1c2, t1c3, t2c0, t2c1, t2c2, t2c3, t3c0, t3c1, t3c2, and t3c3. In this example, the “t” index may indicate a time position or frame position, and the “c” index may indicate an audio channel, such as one of a plurality of microphone channels.

In some examples, the current feature-domain portion Ft may include feature-domain representations corresponding to selected time-domain samples or frames. For example, the current feature-domain portion Ft may include feature entries such as Feat. T0C0, Feat. T0C1, Feat. T0C2, Feat. T0C3, Feat. T2C0, Feat. T2C1, Feat. T2C2, and Feat. T2C3. The current mask portion FMask, t may include corresponding mask entries, such as Mask T0C0, Mask T0C1, Mask T0C2, Mask T0C3, Mask T2C0, Mask T2C1, Mask T2C2, and Mask T2C3.

In some examples, the offset feature-domain portion Ft-n/2 and the offset mask portion FMask, t-n/2 may represent feature and mask data associated with offset or overlapping frames. For example, the offset feature-domain portion Ft-n/2 may include feature entries such as Feat. T-1C2, Feat. T-1C3, Feat. T1C0, Feat. T1C1, Feat. T1C2, Feat. T1C3, Feat. T3C0, and Feat. T3C1. The offset mask portion FMask, t-n/2 may include corresponding mask entries such as Mask T-1C2, Mask T-1C3, Mask T1C0, Mask T1C1, Mask T1C2, Mask T1C3, Mask T3C0, and Mask T3C1.

In some examples, the offset feature-domain portion Ft-n/2 and the offset mask portion FMask, t-n/2 may be used when a feature encoder generates overlapping feature frames. For instance, a short-time Fourier transform may generate feature frames with 50% overlap. In such an example, feature data and mask data for one time interval may overlap with feature data and mask data for another time interval, and the three-element buffer arrangement 400 may preserve the relationship between the time-domain samples, the current feature-domain data, the offset feature-domain data, the current mask data, and the offset mask data.

In some examples, the three-element buffer arrangement 400 may support even and odd frame handling. For instance, where feature-domain data and mask data have 50% overlap, two pairs of buffers may be used for even-numbered and odd-numbered frames. The particular offset shown by the offset feature-domain portion Ft-n/2 and the offset mask portion FMask, t-n/2 may therefore reflect a feature-frame relationship associated with the transform used by the feature encoder.

In some examples, the feature-domain portions Ft and Ft-n/2 may include STFT spectrum data, and the mask portions FMask, t and FMask, t-n/2 may include masks generated by one or more AI models for application to the STFT spectrum data. In various examples, the three-element buffer arrangement 400 is not limited to STFT-based features. Other examples may use learned transforms, filter-bank features, frequency-domain representations, time-frequency representations, or other feature representations. The layout of the three-element buffer arrangement 400 may differ depending on the encoder type, decoder type, frame length, overlap amount, channel count, sampling rate, or mask definition.

In some examples, the three-element buffer arrangement 400 enables different processing blocks to access different types of information. For instance, an AI model may access feature-domain data in the current feature-domain portion Ft, feature-domain data in the offset feature-domain portion Ft-n/2, mask data in the current mask portion FMask, t, mask data in the offset mask portion FMask, t-n/2, or a combination thereof. A copier or output block may access only the time-domain portion Tt when transmitting conventional time-domain samples to an operating system. Thus, the three-element buffer arrangement 400 may support both shared feature-domain AI processing and compatibility with time-domain audio outputs.

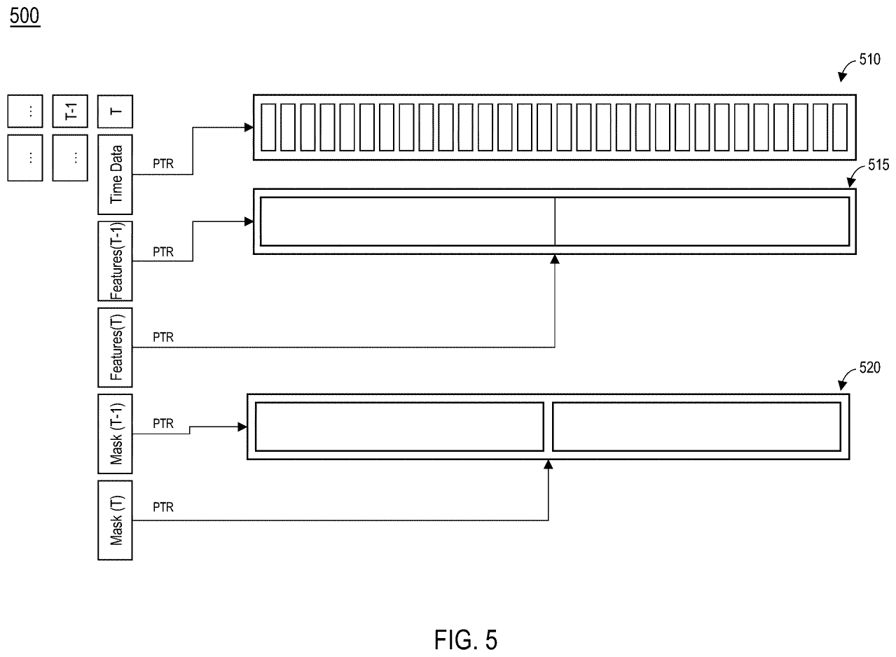

FIG. 5 illustrates an example queue implementation 500 for managing multiple data types in an audio processing pipeline, in accordance with various embodiments. In some examples, the queue implementation 500 may be used to implement or manage a three-element buffer, such as the three-element buffer arrangement 400 of FIG. 4. The queue implementation 500 may include entries corresponding to Time Data, Features(T-1), Features(T), Mask(T-1), and Mask(T), which may represent time-domain samples, feature-domain samples for a previous or offset frame, feature-domain samples for a current frame, mask data for a previous or offset frame, and mask data for a current frame, respectively.

In some examples, the queue implementation 500 includes a sample buffer 510, a feature buffer 515, and a mask buffer 520. The sample buffer 510 may store time-domain samples, such as PCM samples, for one or more frames or channels. The feature buffer 515 may store feature-domain data associated with one or more time intervals, including feature data corresponding to Features(T-1) and Features(T). The mask buffer 520 may store mask data associated with one or more time intervals, including mask data corresponding to Mask(T-1) and Mask(T).

In some examples, the mask buffer 520 stores mask-processed data generated by one or more AI models. The mask-processed data may include an original feature mask, an updated feature mask, an accumulated feature mask, or other mask information generated based on one or more masks. During processing through a plurality of AI models, the mask buffer 520 may be updated to replace previous mask information with updated mask information, or may store pointers to successive versions of mask information generated by the plurality of AI models. In one example, a first AI model writes first mask-processed data to the mask buffer 520, and a second AI model reads the first mask-processed data and writes second mask-processed data to the mask buffer 520. The second mask-processed data may then be used by a mask application block to modify feature-domain data after processing by the plurality of AI models. In this manner, the queue implementation 500 may support both intermediate application of masks to feature-domain data and deferred application of an updated mask at an end of an AI model sequence.

In some examples, the queue implementation 500 uses pointers PTR to reference memory locations within the sample buffer 510, the feature buffer 515, and the mask buffer 520. A Time Data entry may include a pointer PTR to a corresponding location in the sample buffer 510. A Features(T-1) entry and a Features(T) entry may include respective pointers PTR to corresponding locations in the feature buffer 515. A Mask(T-1) entry and a Mask(T) entry may include respective pointers PTR to corresponding locations in the mask buffer 520.

In some examples, the use of pointers PTR allows the queue implementation 500 to transmit or identify multiple related data elements without copying each data element between processing blocks. For example, instead of duplicating time-domain samples, feature-domain samples, and mask data for each stage of an audio processing pipeline, the queue implementation 500 may pass references to memory locations that already store the relevant data. This may reduce memory bandwidth, reduce processing overhead, and facilitate efficient operation in firmware or another resource-constrained processing environment.

In some examples, the sample buffer 510 may be arranged as a sequence of sample slots for time-domain data, while the feature buffer 515 may be arranged as a larger or differently structured memory region for feature-domain data. The mask buffer 520 may similarly be arranged as a memory region for feature masks. The respective sizes and layouts of the sample buffer 510, the feature buffer 515, and the mask buffer 520 may depend on the sampling rate, channel count, frame size, transform type, overlap amount, and mask format used in a particular implementation.

In some examples, the queue implementation 500 may support overlapping feature frames. For instance, Features(T-1) and Features(T) may correspond to adjacent or partially overlapping feature frames, and Mask(T-1) and Mask(T) may correspond to masks generated for those feature frames. Where a transform uses 50% overlap, the queue implementation 500 may maintain references to previous and current feature and mask buffers so that reconstruction, mask application, and downstream processing can be performed using the correct temporal alignment.

In some examples, the queue implementation 500 may enable a processing pipeline to handle a three-element buffer while maintaining compatibility with processing blocks that use only selected parts of the buffer. For example, an AI processing block may use pointers PTR associated with the feature buffer 515 and the mask buffer 520, while a copier or output block may use a pointer PTR associated with the sample buffer 510 to output time-domain data. Thus, in various examples, the queue implementation 500 may allow different blocks to consume different portions of a common queue entry.

In some examples, the queue implementation 500 may be used when expanded audio-frame information is transmitted between endpoint effect blocks, mode effect blocks, copier blocks, or other firmware modules. The expanded audio-frame information may include time-domain samples, feature-domain samples, and mask data, thereby enabling multiple AI models to share common feature-domain information. By sharing the feature-domain information, the processing pipeline can avoid repeated feature encoding and feature decoding operations for different AI models.

In some examples, the queue implementation 500 may help mitigate the memory impact of transmitting additional information through the audio processing pipeline. The queue implementation 500 may reuse memory, maintain pointers PTR to existing buffer regions, and avoid unnecessary copies. In various examples, the queue implementation 500 may therefore provide an efficient mechanism for enabling latency-optimized AI processing while managing the increased data associated with shared feature-domain samples and feature masks.

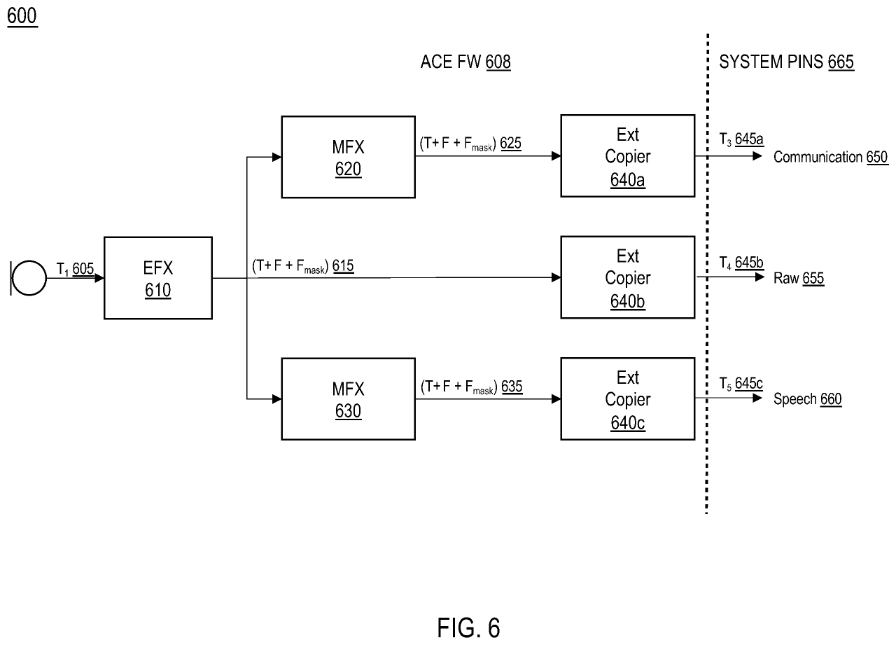

FIG. 6 illustrates an example modified audio processing architecture 600, in accordance with various embodiments. In some examples, the modified audio processing architecture 600 may be implemented in audio firmware, such as Audio and Context Engine (ACE) firmware 608 of a computing device or system-on-chip. The modified audio processing architecture 600 may receive a time-domain input signal T1 605 and may generate multiple output signals for respective system pins 665, including a communication output 650, a raw output 655, and a speech output 660.

In some examples, the time-domain input signal T1 605 may be received by an endpoint effect block EFX 610. The EFX 610 may perform processing that is applied to multiple downstream audio streams or pins. For example, the EFX 610 may perform processing that is common to each of the communication output 650, the raw output 655, and the speech output 660. The EFX 610 may include (or operate in coordination with) one or more AI-based processing operations.

In some examples, the EFX 610 may output expanded audio-frame information 615. The expanded audio-frame information 615 may include time-domain samples T, feature-domain samples F, and feature mask information Fmask. The feature-domain samples F may correspond to a feature representation generated from the time-domain input signal T1 605, and the feature mask information Fmask may correspond to mask data generated by one or more AI models to be applied to the feature-domain samples F.

In some examples, the expanded audio-frame information 615 may be provided from the EFX 610 to one or more downstream branches of the modified audio processing architecture 600. A first branch may include a mode effect block MFX 620 and an extended copier 640a. The MFX 620 may perform processing specific to a particular stream or use case, such as a communication stream, and may output further expanded audio-frame information 625 including time-domain samples T, feature-domain samples F, and feature mask information Fmask. The extended copier 640a may receive the expanded audio-frame information 625 and may output a selected time-domain signal T3 645a to the communication output 650.

In some examples, a second branch may include an extended copier 640b that receives the expanded audio-frame information 615 from the EFX 610. The extended copier 640b may select a portion of the expanded audio-frame information 615 for output to the raw output 655. For example, the extended copier 640b may output a time-domain signal T4 645b to the raw output 655 while omitting feature-domain samples F and feature mask information Fmask from the data transmitted to the corresponding system pin 665.

In some examples, a third branch may include a mode effect block MFX 630 and an extended copier 640c. The MFX 630 may perform stream-specific processing for the speech output 660 and may output expanded audio-frame information 635 including time-domain samples T, feature-domain samples F, and feature mask information Fmask. The extended copier 640c may receive the expanded audio-frame information 635 and may output a selected time-domain signal T5 645c to the speech output 660.

In some examples, the extended copiers 640a, 640b, and 640c may be configured to receive expanded audio-frame information that includes more than time-domain samples. The extended copiers 640a, 640b, and 640c may select which portion of the expanded audio-frame information is transmitted to the system pins 665. For example, the extended copiers 640a, 640b, and 640c may transmit only time-domain signals T3 645a, T4 645b, and T5 645c to maintain compatibility with an operating system, driver, application, or other downstream consumer that expects time-domain audio samples.

In some examples, the selected portion transmitted by an extended copier is the time-domain portion of the expanded audio-frame information, and the extended copier does not transmit the feature-domain samples or feature-mask information to a system pin that is configured to receive time-domain audio samples.

In some examples, transmitting time-domain samples T, feature-domain samples F, and feature mask information Fmask between the EFX 610 and the MFX 620 and 630 enables multiple AI processing blocks to share a common feature-domain representation. This may allow feature encoding and feature decoding operations to be performed fewer times than in an architecture in which each AI processing block receives and outputs only time-domain samples. For instance, feature-domain samples F generated for one AI model may be reused by another AI model, and feature mask information Fmask generated by one block may be made available to downstream processing.

In some examples, the modified audio processing architecture 600 may reduce accumulated latency in real-time audio processing. By carrying the expanded audio-frame information 615, 625, and 635 through portions of the ACE firmware 608, the modified audio processing architecture 600 may avoid repeated conversions between time-domain data and feature-domain data for multiple AI processing modules. The modified audio processing architecture 600 may thereby reduce latency, compute usage, memory usage, or power consumption while preserving compatibility with system pins 665 that receive time-domain output signals.

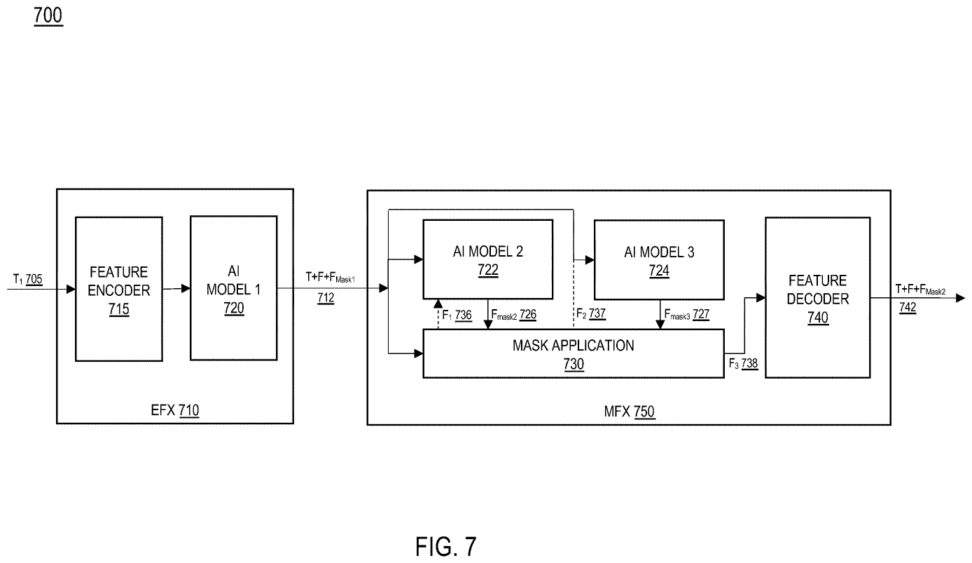

FIG. 7 illustrates an example processing architecture 700 in which a latency-optimized AI processing pipeline is mapped to an endpoint effect and mode effect architecture, in accordance with various embodiments. In some examples, the processing architecture 700 may be implemented in audio firmware of a computing device, such as firmware executed by an audio subsystem of a system-on-chip. The processing architecture 700 may receive a time-domain input signal T1 705 and may perform multiple AI-based audio processing operations while reducing repeated conversions between a time domain and a feature domain.

In some examples, the time-domain input signal T1 705 is received by an endpoint effect block EFX 710. The EFX 710 may include a feature encoder 715 and an AI model 1 720. The feature encoder 715 may convert the time-domain input signal T1 705 into feature-domain data. For example, the feature encoder 715 may perform a short-time Fourier transform, a filter-bank transform, a learned transform, or another suitable transform that generates feature-domain data for use by one or more AI models.

In some examples, the AI model 1 720 may process the feature-domain data generated by the feature encoder 715 to generate first mask information. The EFX 710 may output expanded audio-frame information that includes time-domain samples T, feature-domain samples F, and first feature mask information FMask1. By outputting the time-domain samples T together with the feature-domain samples F and the first feature mask information FMask1, the EFX 710 may allow downstream processing stages to continue operating in the feature domain without using a separate feature encoder at each downstream AI processing stage.

In some examples, the expanded audio-frame information output by the EFX 710 may be provided to a mode effect block MFX 750. The MFX 750 may include an AI model 2 722, an AI model 3 724, a mask application block 730, and a feature decoder 740. The MFX 750 may be associated with a particular audio stream, mode, or output pin, such that processing performed within the MFX 750 may be applied to a selected audio stream rather than being applied to all audio streams.

In some examples, the AI model 2 722 may receive feature-domain information from the expanded audio-frame information provided by the EFX 710. The AI model 2 722 may generate second mask information Fmask2 726 based on the received feature-domain information, based on a result of processing by the AI model 1 720, or based on both. The second mask information Fmask2 726 may be provided to the mask application block 730 to modify the feature-domain data.

In some examples, the AI model 3 724 may receive original feature-domain information, feature-domain information modified using the second mask information Fmask2 726, mask information generated by an upstream AI model, or a combination thereof. The AI model 3 724 may generate third mask information Fmask3 727. The third mask information Fmask3 727 may be provided to the mask application block 730 to perform an additional feature-domain modification. The AI model 2 722 and the AI model 3 724 may perform different audio processing functions, such as echo reduction, noise reduction, automatic gain control, speech enhancement, or another audio enhancement operation.

In some examples, the mask application block 730 may apply one or more masks to feature-domain data to generate modified feature-domain data. For instance, the mask application block 730 may generate feature-domain data F1 736, F2 737, and F3 738 corresponding to successive stages of feature-domain processing. The feature-domain data F1 736, F2 737, and F3 738 may represent intermediate or output feature-domain representations generated after application of one or more masks generated by the AI model 1 720, the AI model 2 722, and the AI model 3 724.

In some examples, the feature decoder 740 may receive the modified feature-domain data from the mask application block 730 and convert the modified feature-domain data into a time-domain output signal. The feature decoder 740 may perform an inverse transform corresponding to the transform performed by the feature encoder 715, such as an inverse short-time Fourier transform or another suitable feature-to-time conversion. In some examples, after the feature decoder 740, a time-domain output 742 may be generated for a downstream component, operating system, driver, application, or system pin.

In some examples, the processing architecture 700 may also transmit expanded audio-frame information T+F+FMask2 712 from the MFX 750 or within the MFX 750. The expanded audio-frame information T+F+FMask2 712 may include time-domain samples T, feature-domain samples F, and second feature mask information FMask2. Such expanded information may be used by downstream processing blocks, additional mode effect blocks, or other firmware components that can utilize feature-domain data or mask data without performing an additional feature encoding operation.

In some examples, the processing architecture 700 reduces latency by placing the feature encoder 715 upstream of multiple AI models and placing the feature decoder 740 downstream of multiple AI models. In this manner, the AI model 1 720, the AI model 2 722, and the AI model 3 724 may share feature-domain information rather than each being implemented in a separate processing block with its own feature encoder and feature decoder. The processing architecture 700 may therefore reduce accumulated latency, compute usage, memory usage, and power consumption while allowing multiple AI-based audio processing functions to be performed in an endpoint effect and mode effect architecture.

### Example Method for Latency-Optimized AI Audio Processing

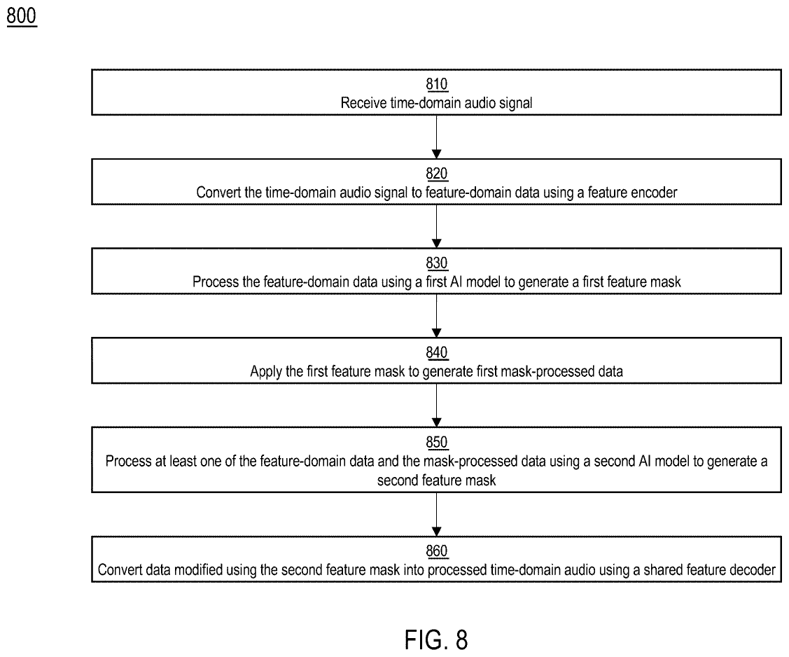

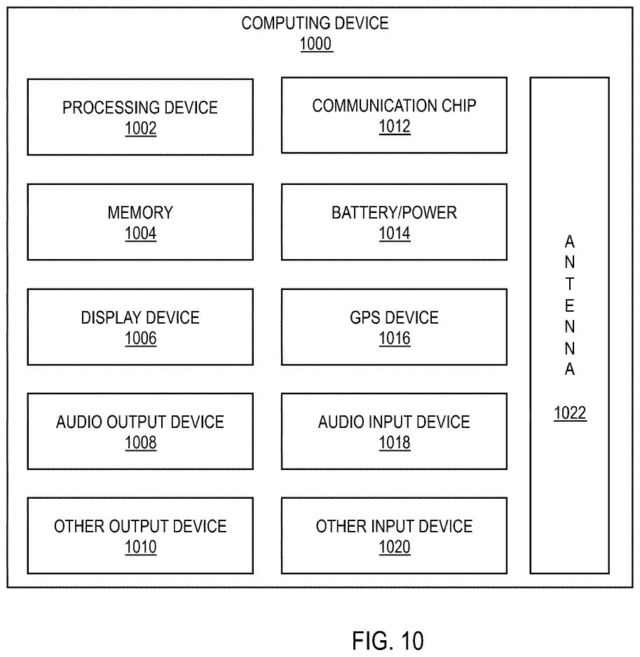

FIG. 8 is a flowchart illustrating a method 800 for latency-optimized AI audio processing, in accordance with various embodiments. The method 800 may be performed by audio firmware, an audio processing subsystem, a system-on-chip, another system that performs real-time audio processing, and/or by the computing device 1000 in FIG. 10. Although the method 800 is described with reference to the flowchart illustrated in FIG. 8, many other methods for latency-optimized AI audio processing may alternatively be used. For example, the order of execution of the steps in FIG. 8 may be changed. As another example, some of the steps may be changed, eliminated, or combined. The method 800 may be used for teleconferencing, gaming, audio recording, voice communication, speech capture, or another audio use case in which reduced latency is desirable.

At 810, the method 800 includes receiving a time-domain audio signal. In some examples, the time-domain audio signal includes pulse-code modulation (PCM) samples captured by one or more microphones of a computing device. The time-domain audio signal may include speech, background noise, echo, reverberation, or other audio components. In some examples, the time-domain audio signal is received by an audio firmware pipeline before being provided to an operating system, application, or system pin.

At 820, the method 800 includes converting the time-domain audio signal to feature-domain data using a feature encoder. In some examples, the feature encoder is a shared feature encoder used for multiple AI models in an audio processing pipeline. The feature encoder may perform a short-time Fourier transform (STFT), a filter-bank transform, a learned transform, or another time-to-feature conversion. The feature-domain data may include frequency-domain data, time-frequency data, feature vectors, spectral bins, or other feature representations derived from the time-domain audio signal.

At 830, the method 800 includes processing the feature-domain data using a first AI model to generate a first feature mask. In some examples, the first AI model performs a first audio processing operation, such as echo reduction, noise reduction, automatic gain control, speech enhancement, dereverberation, or another audio enhancement operation. The first feature mask may identify portions of the feature-domain data to suppress, amplify, preserve, attenuate, or otherwise modify.

At 840, the method 800 includes applying the first feature mask to generate mask-processed data. In some examples, the first feature mask is applied to the feature-domain data by a mask application block. In some examples, the mask-processed data is modified feature-domain data. The modified feature-domain data may represent the audio signal after a first AI-based processing operation has been performed in the feature domain. In various examples, the mask-processed data remains in the feature domain for further processing.

At 850, the method 800 includes processing, at a second AI model, at least one of the feature-domain data and the mask-processed data, to generate a second feature mask. In some examples, the second AI model may receive the original feature-domain data generated at 820, the modified feature-domain data generated at 840, or both the original feature-domain data generated at 820 and the mask-processed data generated at 840. In various examples, the input selection for the second AI model may be predetermined by a pipeline designer, selected based on a particular audio use case, or learned during training of the AI processing pipeline.

In some examples, the second AI model performs a different audio processing operation than the first AI model. For example, the first AI model may perform echo reduction and the second AI model may perform noise reduction or gain control. In other examples, the first AI model and the second AI model may perform related processing operations or may be trained together to improve overall audio quality. Additional AI models may also be used, and each additional AI model may process original feature-domain data, previously modified feature-domain data, one or more previously generated feature masks, or combinations thereof.

In some examples, the method 800 further includes transmitting expanded audio-frame information between audio processing modules. The expanded audio-frame information may include time-domain samples, feature-domain data, and feature-mask data. For example, the expanded audio-frame information may be transmitted between an endpoint effect block, a mode effect block, and a copier block in audio firmware. In some examples, the expanded audio-frame information allows downstream processing modules to access feature-domain data or feature-mask data without performing a separate feature encoding operation.

In some examples, the expanded audio-frame information may be stored, referenced, and/or transmitted using a multi-element buffer. The multi-element buffer may include time-domain audio samples, feature-domain samples, and feature-mask data. In some examples, pointers may be used to identify locations of the time-domain audio samples, feature-domain samples, and feature-mask data in memory, thereby reducing copying of audio data through the pipeline. In some examples, a copier or output block may select a time-domain portion of the expanded audio-frame information for output to an operating system, application, system pin, and/or other downstream component.

At 860, the method 800 includes converting data modified using the second feature mask into processed time-domain audio using a shared feature decoder. In some examples, the second feature mask is applied to feature-domain data to generate further modified feature-domain data, and the shared feature decoder converts the further modified feature-domain data into processed time-domain audio. The shared feature decoder may perform an inverse STFT, an inverse filter-bank transform, an inverse learned transform, or another feature-to-time conversion corresponding to the feature encoder used at 820.

In some examples, generating mask-processed data based on a feature mask includes applying the feature mask to feature-domain data to generate modified feature-domain data. In other examples, generating mask-processed data based on the feature mask includes updating mask information without applying the feature mask to the feature-domain data at that stage of the method 800. For example, a first feature mask may be used to generate first mask-processed data comprising an updated feature mask. A second feature mask may then be generated based on the feature-domain data, the first mask-processed data, or both, and the second feature mask may be used with the first mask-processed data to generate second mask-processed data. The second mask-processed data may comprise a last updated feature mask, and the method 800 may include applying the last updated feature mask to the feature-domain data after processing by the plurality of AI models. The shared feature decoder may then convert feature-domain data modified using the last updated feature mask into processed time-domain audio. In some examples, deferring application of feature masks until after the plurality of AI models have generated or updated mask information reduces multiplication operations relative to applying each feature mask separately to feature-domain data at each stage of the plurality of AI models.

By using a shared feature encoder at 820 and a shared feature decoder at 860, the method 800 may reduce latency relative to a cascaded pipeline in which each AI model has its own feature encoder and feature decoder. For example, feature encoding and feature decoding may be performed once for multiple AI models rather than separately for each AI model. The method 800 may thereby reduce accumulated latency, compute usage, memory usage, and power consumption while enabling multiple AI-based audio processing operations to be performed in a common feature domain.

### Example DNN System

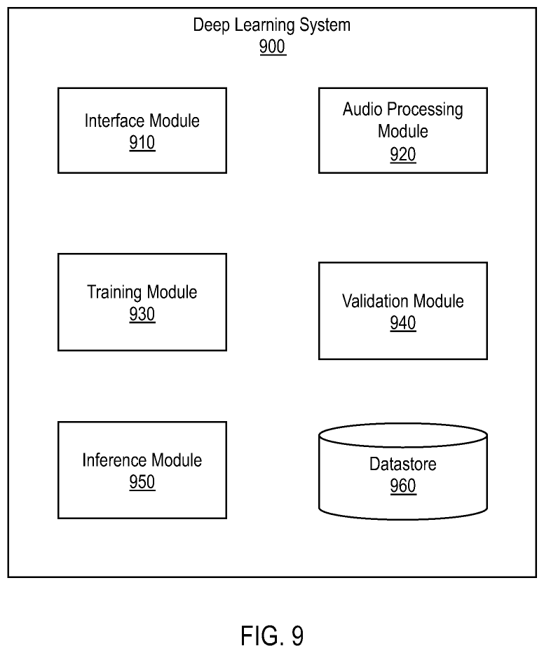

FIG. 9 is a block diagram of an example deep learning system 900, in accordance with various embodiments. The deep learning system 900 trains and/or executes deep neural networks or other AI models for various tasks, including AI-based audio processing, feature mask generation, echo reduction, noise reduction, automatic gain control, speech enhancement, and/or other audio enhancement operations. The deep learning system 900 includes an interface module 910, an audio processing module 920, a training module 930, a validation module 940, an inference module 950, and a datastore 960. In other embodiments, alternative configurations, different or additional components may be included in the deep learning system 900. Further, functionality attributed to a component of the deep learning system 900 may be accomplished by a different component included in the deep learning system 900 or a different system. The deep learning system 900 or a component of the deep learning system 900 (e.g., the training module 930 or inference module 950) may include the computing device 1000 in FIG. 10. The deep learning system 900 may be used to train or validate AI models that are deployed in a latency-optimized audio processing pipeline, such as the AI models 220, 222, and 224 of FIG. 2 or the AI models 720, 722, and 724 of FIG. 7. In some examples, the deep learning system 900 trains one or more AI models to generate feature masks for use with a shared feature encoder and a shared feature decoder.

The interface module 910 facilitates communication of the deep learning system 900 with other systems. As an example, the interface module 910 supports the deep learning system 900 to distribute trained AI models to other systems, e.g., computing devices configured to apply the AI models to perform tasks. As another example, the interface module 910 establishes communication between the deep learning system 900 and an external database to receive data that can be used to train AI models or input into AI models to perform tasks. In some embodiments, data received by the interface module 910 may have a data structure, such as a matrix. In some embodiments, data received by the interface module 910 may be audio data, time-domain samples, feature-domain samples, feature masks, and/or other audio processing data.

The audio processing module 920 performs AI-based audio processing in real time. The audio processing module 920 can perform AI-based audio processing in real time on a user's computing device. In general, the audio processing module 920 receives input audio data, such as time-domain audio samples, and generates feature-domain data, one or more feature masks, and/or processed audio data. The processed audio data can have reduced echo, reduced noise, adjusted gain, enhanced speech, and/or other improved audio characteristics. The processed audio data can be transmitted to one or more downstream audio components, applications, operating-system components, system pins, or listener devices. In some examples, the audio processing module 920 may implement, include, or control one or more portions of a latency-optimized AI audio processing pipeline.

To perform AI-based audio processing, the audio processing module 920 identifies features of the audio data to alter or remove from the audio data and generates or applies one or more feature masks. In some examples, the audio processing module 920 includes a feature encoder, one or more AI models, a mask application block, a feature decoder, and/or buffer-management logic for time-domain samples, feature-domain samples, and feature masks. For example, the audio processing module 920 may implement or cooperate with one or more audio processing components described with respect to FIG. 2 or FIG. 7. In some examples, the buffer-management logic of the audio processing module 920 manages expanded audio-frame information including time-domain samples, feature-domain samples, and feature-mask data. The buffer-management logic may maintain pointers to a sample buffer, a feature buffer, and a mask buffer, as described with respect to FIG. 5.

The training module 930 trains AI models by using training datasets. In some embodiments, a training dataset for training an AI model may include one or more audio samples, each of which may be a training sample. In some examples, the training module 930 trains the audio processing module 920 and/or one or more AI models used by the audio processing module 920. The training module 930 may receive real-world audio data for processing with the audio processing module 920 as described herein. In some embodiments, the training module 930 may input different data into different layers of the AI model. For every subsequent AI model layer, the input data may be less than the previous AI model layer.

In some embodiments, a part of the training dataset may be used to initially train the AI model, and the rest of the training dataset may be held back as a validation subset used by the validation module 940 to validate performance of a trained AI model. The portion of the training dataset not including the tuning subset and the validation subset may be used to train the AI model.

The training module 930 also determines hyperparameters for training the AI model. Hyperparameters are variables specifying the AI model training process. Hyperparameters are different from parameters inside the AI model (e.g., weights of filters). In some embodiments, hyperparameters include variables determining the architecture of the AI model, such as number of hidden layers, etc. Hyperparameters also include variables which determine how the AI model is trained, such as batch size, number of epochs, etc. A batch size defines the number of training samples to work through before updating the parameters of the AI model. The batch size is the same as or smaller than the number of samples in the training dataset. The training dataset can be divided into one or more batches. The number of epochs defines how many times the entire training dataset is passed forward and backwards through the entire network. The number of epochs defines the number of times that the deep learning algorithm works through the entire training dataset. One epoch means that each training sample in the training dataset has had an opportunity to update the parameters inside the AI model. An epoch may include one or more batches. The number of epochs may be 1, 10, 50, 100, or even larger.

The training module 930 defines the architecture of the AI model, e.g., based on some of the hyperparameters. The architecture of the AI model includes an input layer, an output layer, and a plurality of hidden layers. The input layer of the AI model may include tensors (e.g., a multidimensional array) specifying attributes of the input audio data, such as frame size, channel count, sampling rate, time-domain sample representation, feature-domain representation, and/or mask information. The output layer includes model outputs, such as one or more feature masks or other audio processing outputs. The hidden layers are layers between the input layer and output layer. The hidden layers include one or more convolutional layers and one or more other types of layers, such as pooling layers, fully connected layers, normalization layers, softmax or logistic layers, and so on. The convolutional layers of the AI model abstract the input audio data to a feature map that is represented by a tensor specifying the feature map dimensions and channels. A pooling layer is used to reduce the volume of input data after convolution. It is used between two convolutional layers. A fully connected layer involves weights, biases, and neurons. It connects neurons in one layer to neurons in another layer. It may be used to generate or classify audio processing outputs by training.

In the process of defining the architecture of the AI model, the training module 930 also adds an activation function to a hidden layer or the output layer. An activation function of a layer transforms the weighted sum of the input of the layer to an output of the layer. The activation function may be, for example, a rectified linear unit activation function, a tangent activation function, or other types of activation functions.

After the training module 930 defines the architecture of the AI model, the training module 930 inputs a training dataset into the AI model. The training dataset includes a plurality of training samples. An example of a training dataset includes a series of audio samples from an audio stream. Unlabeled, real-world audio samples are input to the audio processing module 920, and processed using the calibration parameters of the AI model to produce model-generated outputs. In some examples, a first model-generated output can be based on a first set of captured audio samples from the audio processing module 920 and a second model-generated output can be based on a second set of audio samples from the audio processing module 920. The processed audio data, feature-domain data, and/or feature masks can be compared to the input audio or to reference audio processing outputs. The internal parameters include weights of filters in the convolutional layers of the AI model. In some embodiments, the training module 930 uses a cost function to minimize the differences. In some examples, the AI model performs feature detection on each of the input audio samples, and the AI model performs pairwise feature matching between or among audio samples in a set (e.g., the first set of audio samples, the second set of audio samples).

The training module 930 may train the AI model for a predetermined number of epochs. The number of epochs is a hyperparameter that defines the number of times that the deep learning algorithm will work through the entire training dataset. One epoch means that each sample in the training dataset has had an opportunity to update internal parameters of the AI model. After the training module 930 finishes the predetermined number of epochs, the training module 930 may stop updating the parameters in the AI model. The AI model having the updated parameters is referred to as a trained AI model.

The validation module 940 verifies the accuracy of trained AI models. In some embodiments, the validation module 940 inputs samples in a validation dataset into a trained AI model and uses the outputs of the AI model to determine the model accuracy. In some embodiments, a validation dataset may be formed of some or all the samples in the training dataset. Additionally or alternatively, the validation dataset includes additional samples, other than those in the training sets. In some embodiments, the validation module 940 may determine an accuracy score measuring the precision, recall, or a combination of precision and recall of the AI model. The validation module 940 may use the following metrics to determine the accuracy score: Precision=TP/(TP+FP) and Recall=TP/(TP+FN), where precision may be how many the reference classification model correctly predicted (TP or true positives) out of the total it predicted (TP+FP or false positives), and recall may be how many the reference classification model correctly predicted (TP) out of the total number of objects that did have the property in question (TP+FN or false negatives). The F-score (F-score=2*PR/(P+R)) unifies precision and recall into a single measure.

The validation module 940 may compare the accuracy score with a threshold score. In an example where the validation module 940 determines that the accuracy score of the AI model is lower than the threshold score, the validation module 940 instructs the training module 930 to re-train the AI model. In one embodiment, the training module 930 may iteratively re-train the AI model until the occurrence of a stopping condition, such as the accuracy measurement indicating that the AI model may be sufficiently accurate, or a number of training rounds having taken place.

The inference module 950 applies the trained or validated AI model to perform tasks. The inference module 950 may run inference processes of a trained or validated AI model. In some examples, inference makes use of the forward pass to produce model-generated output for unlabeled real-world data. For instance, the inference module 950 may input real-world audio data into the AI model and receive an output of the AI model. The output of the AI model may provide a solution to the task for which the AI model is trained, such as a feature mask, an enhanced audio representation, or another audio processing output.

The inference module 950 may aggregate the outputs of the AI model to generate a final result of the inference process. In some embodiments, the inference module 950 may distribute the AI model to other systems, e.g., computing devices in communication with the deep learning system 900, for the other systems to apply the AI model to perform the tasks. The distribution of the AI model may be done through the interface module 910. In some embodiments, the deep learning system 900 may be implemented in a server, such as a cloud server, an edge service, and so on. The computing devices may be connected to the deep learning system 900 through a network. Examples of the computing devices include edge devices and user computing devices having audio processing firmware.

The datastore 960 stores data received, generated, used, or otherwise associated with the deep learning system 900. For example, the datastore 960 stores audio data, training samples, validation samples, feature-domain data, feature masks, processed audio data, and/or model data processed by the audio processing module 920 or used by the training module 930, validation module 940, and the inference module 950. The datastore 960 may also store other data generated by the training module 930 and validation module 940, such as the hyperparameters for training AI models, internal parameters of trained AI models, etc. In the embodiment of FIG. 9, the datastore 960 is a component of the deep learning system 900. In other embodiments, the datastore 960 may be external to the deep learning system 900 and communicate with the deep learning system 900 through a network.

### Example Computing Device

FIG. 10 is a block diagram of an example computing device 1000, in accordance with various embodiments. In some embodiments, the computing device 1000 may be used for at least part of the systems in FIGS. 1A-9. A number of components are illustrated in FIG. 10 as included in the computing device 1000, but any one or more of these components may be omitted or duplicated, as suitable for the application. In some embodiments, some or all of the components included in the computing device 1000 may be attached to one or more motherboards. In some embodiments, some or all of these components are fabricated onto a single system on a chip (SoC) die. Additionally, in various embodiments, the computing device 1000 may not include one or more of the components illustrated in FIG. 10, but the computing device 1000 may include interface circuitry for coupling to the one or more components. For example, the computing device 1000 may not include a display device 1006, but may include display device interface circuitry (e.g., a connector and driver circuitry) to which a display device 1006 may be coupled. In another set of examples, the computing device 1000 may not include an audio input device 1018 or an audio output device 1008, but may include audio input or output device interface circuitry (e.g., connectors and supporting circuitry) to which an audio input device 1018 or an audio output device 1008 may be coupled.

The computing device 1000 may include a processing device 1002 (e.g., one or more processing devices). The processing device 1002 processes electronic data from registers and/or memory to transform that electronic data into other electronic data that may be stored in registers and/or memory. The computing device 1000 may include a memory 1004, which may itself include one or more memory devices such as volatile memory (e.g., DRAM), nonvolatile memory (e.g., read-only memory (ROM)), high-bandwidth memory (HBM), flash memory, solid-state memory, and/or a hard drive. In some embodiments, the memory 1004 may include memory that shares a die with the processing device 1002. In some embodiments, the memory 1004 includes one or more non-transitory computer-readable media storing instructions executable for latency-optimized AI audio processing, e.g., the method 800 described above in conjunction with FIG. 8 or some operations performed by the deep learning system 900 in FIG. 9. The instructions stored in the one or more non-transitory computer-readable media may be executed by the processing device 1002.

In some embodiments, the computing device 1000 may include a communication chip 1012 (e.g., one or more communication chips). For example, the communication chip 1012 may be configured for managing wireless communications for the transfer of data to and from the computing device 1000. The term “wireless” and its derivatives may be used to describe circuits, devices, systems, methods, techniques, communications channels, etc., that may communicate data using modulated electromagnetic radiation through a non-solid medium. The term does not imply that the associated devices do not contain any wires, although in some embodiments they might not.

The communication chip 1012 may implement any of a number of wireless standards or protocols, including but not limited to Institute for Electrical and Electronic Engineers (IEEE) standards including Wi-Fi (IEEE 802.11 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are generally referred to as WiMAX networks, an acronym that stands for worldwide interoperability for microwave access, which is a certification mark for products that pass conformity and interoperability tests for the IEEE 802.16 standards. The communication chip 1012 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication chip 1012 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chip 1012 may operate in accordance with code-division multiple access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication chip 1012 may operate in accordance with other wireless protocols in other embodiments. The computing device 1000 may include an antenna 1022 to facilitate wireless communications and/or to receive other wireless communications (such as AM or FM radio transmissions).

In some embodiments, the communication chip 1012 may manage wired communications, such as electrical, optical, or any other suitable communication protocols (e.g., the Ethernet). As noted above, the communication chip 1012 may include multiple communication chips. For instance, a first communication chip 1012 may be dedicated to shorter-range wireless communications such as Wi-Fi or Bluetooth, and a second communication chip 1012 may be dedicated to longer-range wireless communications such as global positioning system (GPS), EDGE, GPRS, CDMA, WiMAX, LTE, EV-DO, or others. In some embodiments, a first communication chip 1012 may be dedicated to wireless communications, and a second communication chip 1012 may be dedicated to wired communications.

The computing device 1000 may include battery/power circuitry 1014. The battery/power circuitry 1014 may include one or more energy storage devices (e.g., batteries or capacitors) and/or circuitry for coupling components of the computing device 1000 to an energy source separate from the computing device 1000 (e.g., AC line power).

The computing device 1000 may include a display device 1006 (or corresponding interface circuitry, as discussed above). The display device 1006 may include any visual indicators, such as a heads-up display, a computer monitor, a projector, a touchscreen display, a liquid crystal display (LCD), a light-emitting diode display, or a flat panel display, for example.

The computing device 1000 may include an audio output device 1008 (or corresponding interface circuitry, as discussed above). The audio output device 1008 may include any device that generates an audible indicator, such as speakers, headsets, or earbuds, for example.

The computing device 1000 may include an audio input device 1018 (or corresponding interface circuitry, as discussed above). The audio input device 1018 may include any device that generates a signal representative of a sound, such as microphones, microphone arrays, or digital instruments (e.g., instruments having a musical instrument digital interface (MIDI) output).

The computing device 1000 may include a GPS device 1016 (or corresponding interface circuitry, as discussed above). The GPS device 1016 may be in communication with a satellite-based system and may receive a location of the computing device 1000, as known in the art.

The computing device 1000 may include another output device 1010 (or corresponding interface circuitry, as discussed above). Examples of the other output device 1010 may include a video codec, an audio codec, a printer, a wired or wireless transmitter for providing information to other devices, or an additional storage device.

The computing device 1000 may include another input device 1020 (or corresponding interface circuitry, as discussed above). Examples of the other input device 1020 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

The computing device 1000 may have any desired form factor, such as a handheld or mobile computer system (e.g., a cell phone, a smartphone, a mobile internet device, a music player, a tablet computer, a laptop computer, a netbook computer, an ultrabook computer, a personal digital assistant (PDA), an ultramobile personal computer, etc.), a desktop computer system, a server or other networked computing component, a printer, a scanner, a monitor, a set-top box, an entertainment control unit, a vehicle control unit, a digital camera, a digital video recorder, or a wearable computer system. In some embodiments, the computing device 1000 may be any other electronic device that processes data.

### Select Examples

Example 1 provides an apparatus, including a computer processor for executing computer program instructions; and a non-transitory computer-readable memory storing computer program instructions executable by the computer processor to perform operations including receiving a time-domain audio signal; converting, by a shared feature encoder, the time-domain audio signal into feature-domain data, wherein the shared feature encoder is used to generate the feature-domain data for a plurality of AI models in the audio processing pipeline; processing the feature-domain data using a first AI model of the plurality of AI models to generate a first feature mask; generating first mask-processed data based on the first feature mask; processing at least one of the feature-domain data and the first mask-processed data using a second AI model of the plurality of AI models to generate a second feature mask; generating second mask-processed data based on the second feature mask and the first mask-processed data; and converting the second mask-processed data into processed time-domain audio using a shared feature decoder.
Example 2 provides the apparatus of example 1, where the shared feature decoder is used after processing by the plurality of AI models such that repeated time-domain-to-feature-domain and feature-domain-to-time-domain conversions between the first AI model and the second AI model are avoided.
Example 3 provides the apparatus of example 1 or 2, where the shared feature encoder performs a Short-Time Fourier Transform and the shared feature decoder performs an Inverse Short-Time Fourier Transform.
Example 4 provides the apparatus of any one of examples 1-3, where the second AI model receives both the feature-domain data from the shared feature encoder and the modified feature-domain data as inputs.
Example 5 provides the apparatus of any one of examples 1-4, where the operations further include transmitting between processing modules a three-element buffer including time-domain PCM samples, feature-domain samples, and time-feature masks.
Example 6 provides the apparatus of example 5, where the three-element buffer is implemented as a queue including pointers to consecutive in-memory representations of each of the time-domain PCM samples, the feature-domain samples, and the time-feature masks.
Example 7 provides the apparatus of any one of examples 1-6, where the operations are implemented in Audio and Context Engine (ACE) firmware, and where the first AI model is deployed in an endpoint effect (EFX) module and the second AI model is deployed in a mode effect (MFX) module.
Example 8 provides the apparatus of example 7, where the EFX module applies processing to a plurality of audio streams visible to an operating system and the MFX module applies processing to ones of the plurality of audio streams independently.
Example 9 provides the apparatus of example 7 or 8, where the operations further include transmitting, by an extended Direct Memory Access (DMA) copier, a selected portion of a three-element buffer from the MFX module to an operating system.
Example 10 provides the apparatus of any one of examples 1-9, where the first AI model performs one of echo cancellation, noise reduction, and automatic gain control, and the second AI model performs a different one of echo cancellation, noise reduction, and automatic gain control.
Example 11 provides the apparatus of any one of examples 1-10, where the computer program instructions further include converting the time-domain audio signal to the feature-domain data once for processing by the plurality of AI models.
Example 12 provides the apparatus of any one of examples 1-11, where the computer program instructions, when executed by the computer processor, cause the computer processor to convert processed feature-domain data to processed time-domain audio once after processing by the plurality of AI models.
Example 13 provides the apparatus of any one of examples 1-12, where the plurality of AI models perform different audio processing operations.
Example 14 provides the apparatus of example 13, where the different audio processing operations include two or more of echo reduction, noise reduction, automatic gain control, dereverberation, or speech enhancement.
Example 15 provides the apparatus of any one of examples 1-14, where at least one AI model of the plurality of AI models is to process both the feature-domain data generated from the time-domain audio signal and modified feature-domain data generated using a feature mask from another AI model of the plurality of AI models.
Example 16 provides the apparatus of any one of examples 1-15, where the plurality of AI models includes at least three AI models configured to generate respective feature masks.
Example 17 provides the apparatus of any one of examples 1-16, where the feature encoder includes a short-time Fourier transform encoder and the shared feature decoder includes an inverse short-time Fourier transform decoder.
Example 18 provides the apparatus of any one of examples 1-17, where the computer program instructions, when executed by the computer processor, cause the computer processor to transmit expanded audio-frame information between audio processing modules, the expanded audio-frame information including time-domain data, feature-domain data, and feature-mask data.
Example 19 provides the apparatus of example 18, where the audio processing modules include an endpoint effect block and a mode effect block, and where the expanded audio-frame information is transmitted from the endpoint effect block to the mode effect block.
Example 20 provides the apparatus of example 19, where the endpoint effect block is to perform audio processing for a plurality of output streams, and the mode effect block is to perform stream-specific audio processing for one of the plurality of output streams.
Example 21 provides the apparatus of any one of examples 18-20, where the computer program instructions, when executed by the computer processor, cause the computer processor to select, using an extended copier, time-domain data from the expanded audio-frame information for output to an operating system, an application, or a system pin.
Example 22 provides the apparatus of any one of examples 18-21, where the computer program instructions, when executed by the computer processor, cause the computer processor to store or reference the time-domain data, the feature-domain data, and the feature-mask data using a multi-element buffer.
Example 23 provides the apparatus of example 22, where the multi-element buffer includes one or more pointers to a time-domain sample buffer, a feature-domain buffer, and a mask buffer.
Example 24 provides the apparatus of example 22 or example 23, where the multi-element buffer includes feature-domain data and feature-mask data for overlapping feature frames.
Example 25 provides the apparatus of example 24, where the overlapping feature frames include even-numbered and odd-numbered frames corresponding to a 50% overlap of short-time Fourier transform frames.
Example 26 provides one or more non-transitory computer-readable media storing instructions executable to perform operations, the operations including receiving a time-domain audio signal; converting, by a shared feature encoder, the time-domain audio signal into feature-domain data wherein the shared feature encoder is used to generate the feature-domain data for a plurality of AI models in the audio processing pipeline; processing the feature-domain data using a first AI model of the plurality of AI models to generate a first feature mask; generating first mask-processed data based on the first feature mask; processing at least one of the feature-domain data and the first mask-processed data using a second AI model of the plurality of AI models to generate a second feature mask; generating second mask-processed data based on the second feature mask and the first mask-processed data; and converting the second mask-processed data into processed time-domain audio using a shared feature decoder.
Example 27 provides the one or more non-transitory computer-readable media of example 26, the operations further including processing at least one of the feature-domain data, the modified feature-domain data, and data modified using the second feature mask using a third AI model to generate a third feature mask.
Example 28 provides the one or more non-transitory computer-readable media of example 26 or example 27, the operations further including transmitting between processing modules time-domain PCM samples, feature-domain samples, and time-feature masks, where the time-domain PCM samples, the feature-domain samples, and the time-feature masks are stored in a three-element buffer.
Example 29 provides the one or more non-transitory computer-readable media of example 28, where the three-element buffer is implemented as a queue including pointers to consecutive in-memory representations of each of the time-domain PCM samples, the feature-domain samples, and the time-feature masks.
Example 30 provides the one or more non-transitory computer-readable media of any one of examples 26-29, where the operations are implemented in an Audio and Context Engine (ACE) firmware, and where the first AI model is deployed in an endpoint effect (EFX) module and the second AI model is deployed in a mode effect (MFX) module.
Example 31 provides the one or more non-transitory computer-readable media of example 30, where the EFX module applies processing to a plurality of audio streams visible to an operating system and the MFX module applies processing to one of the plurality of audio streams independently.
Example 32 provides the one or more non-transitory computer-readable media of example 30 or 31, where the operations further include transmitting, by an extended Direct Memory Access (DMA) copier, a selected portion of a three-element buffer from the MFX module to an operating system.
Example 33 provides the one or more non-transitory computer-readable media of any one of examples 26-32, where the first AI model performs one of echo cancellation, noise reduction, and automatic gain control, and the second AI model performs a different one of echo cancellation, noise reduction, and automatic gain control.
Example 34 provides the one or more non-transitory computer-readable media of any one of examples 26-33, where the plurality of AI models share the shared feature encoder and the shared feature decoder.
Example 35 provides a computer-implemented method, including receiving a time-domain audio signal; converting, by a shared feature encoder, the time-domain audio signal into feature-domain data wherein the shared feature encoder is used to generate the feature-domain data for a plurality of AI models in the audio processing pipeline; processing the feature-domain data using a first AI model of the plurality of AI models to generate a first feature mask; generating first mask-processed data based on the first feature mask; processing at least one of the feature-domain data and the first mask-processed data using a second AI model of the plurality of AI models to generate a second feature mask; generating second mask-processed data based on the second feature mask and the first mask-processed data; and converting the second mask-processed data into processed time-domain audio using a shared feature decoder.
Example 36 provides the computer-implemented method of example 35, the operations further including processing at least one of the feature-domain data, the modified feature-domain data, and data modified using the second feature mask using a third AI model to generate a third feature mask.
Example 37 provides the method of example 35 or 36, where the shared feature decoder is shared by the plurality of AI models such that feature-domain data modified by the plurality of AI models is converted to processed time-domain audio once for the plurality of AI models.
Example 38 provides the method of any one of examples 35-37, where the first AI model performs a first audio processing operation and the second AI model performs a second audio processing operation different from the first audio processing operation.
Example 39 provides the method of example 38, where the first audio processing operation and the second audio processing operation include two of echo reduction, noise reduction, automatic gain control, dereverberation, or speech enhancement.
Example 40 provides the method of any one of examples 35-39, where processing at least one of the feature-domain data and the modified feature-domain data using the second AI model includes processing both the feature-domain data and the modified feature-domain data using the second AI model.
Example 41 provides the method of any one of examples 35-40, further including processing at least one of the feature-domain data, the modified feature-domain data, or data modified using the second feature mask using a third AI model to generate a third feature mask.
Example 42 provides the method of any one of examples 35-41, where the feature encoder includes a short-time Fourier transform encoder and the shared feature decoder includes an inverse short-time Fourier transform decoder.
Example 43 provides the method of any one of examples 35-42, further including transmitting expanded audio-frame information between audio processing modules, where the expanded audio-frame information includes time-domain data, the feature-domain data, and feature-mask data.
Example 44 provides the method of example 43, where the expanded audio-frame information is transmitted from an endpoint effect block to a mode effect block in audio firmware.
Example 45 provides the method of example 44, where the endpoint effect block performs audio processing for a plurality of output streams, and the mode effect block performs stream-specific audio processing for one of the plurality of output streams.
Example 46 provides the method of any one of examples 43-45, further including selecting, using an extended copier, time-domain data from the expanded audio-frame information for output to an operating system, an application, or a system pin.
Example 47 provides the method of any one of examples 43-46, further including storing or referencing the time-domain data, the feature-domain data, and the feature-mask data using a multi-element buffer.
Example 48 provides the method of example 47, where the multi-element buffer includes one or more pointers to a time-domain sample buffer, a feature-domain buffer, and a mask buffer.
Example 49 provides the method of example 47 or 48, where the multi-element buffer includes feature-domain data and feature-mask data for overlapping feature frames.
Example 50 provides the method of example 49, where the overlapping feature frames include even-numbered and odd-numbered frames corresponding to a 50% overlap of short-time Fourier transform frames.
Example 51 provides an audio processing system including audio firmware configured to: receive a time-domain audio signal at an endpoint effect block; generate feature-domain data and feature-mask data for the time-domain audio signal; transmit, between audio processing modules, expanded audio-frame information including time-domain data, the feature-domain data, and the feature-mask data; perform stream-specific processing at a mode effect block using at least the feature-domain data and the feature-mask data; and output, using an extended copier, selected time-domain data from the expanded audio-frame information to a system pin.
Example 52 provides a system for audio signal processing including a shared feature encoder configured to transform an input time-domain audio signal into feature-domain representations; a plurality of artificial intelligence models connected in series, wherein each AI model receives as input at least one of the feature-domain representation from the shared feature encoder, mask-processed data generated based on a feature mask from a preceding AI model, and a masked feature output of a preceding AI model, and generates a feature mask for generating further mask-processed data.
Example 53 provides a method for implementing a latency-optimized audio processing pipeline in audio firmware of a system-on-chip, the method including encoding an input time-domain audio signal into feature-domain samples using a feature encoder; processing the feature-domain samples through a plurality of AI models sharing the feature encoder; transmitting between processing modules a three-element buffer including time-domain PCM samples, feature-domain samples, and time-feature masks; selectively providing, to each processing module, one or more elements of the three-element buffer; and decoding the processed feature-domain samples using a single shared feature decoder to produce an output time-domain audio signal.
Example 54 provides an audio processing system, comprising: audio firmware executable by an audio subsystem of a computing device, the audio firmware comprising: an endpoint effect module configured to receive a time-domain audio signal and generate expanded audio-frame information comprising time-domain samples, feature-domain samples generated from the time-domain audio signal, and first feature-mask information generated by a first AI model; a mode effect module configured to receive the expanded audio-frame information from the endpoint effect module and process at least the feature-domain samples using a second AI model to generate second feature-mask information; a mask application block configured to apply the second feature-mask information to feature-domain data to generate modified feature-domain data; a shared feature decoder configured to convert the modified feature-domain data into a processed time-domain signal after processing by the first AI model and the second AI model; and an extended copier configured to output a selected time-domain portion of the expanded audio-frame information or the processed time-domain signal to a system pin while omitting feature-domain samples and feature-mask information from data transmitted to the system pin.
Example 55 provides the apparatus, media, or method of any preceding example, wherein the first mask-processed data comprises updated mask information, wherein the second mask-processed data comprises a last updated feature mask generated based on the updated mask information and the second feature mask, and wherein the last updated feature mask is applied to the feature-domain data after processing by the plurality of AI models.
Example 56 provides an apparatus, including a computer processor for executing computer program instructions; and a non-transitory computer-readable memory storing computer program instructions executable by the computer processor to perform operations including encoding, by a shared feature encoder, a time-domain audio signal into a feature-domain representation; processing the feature-domain representation through a plurality of artificial intelligence (AI) models, each generating a feature mask, where the plurality of AI models are sequentially arranged; generating mask-processed data based on the feature masks; decoding, at a shared feature decoder, the mask-processed data into a processed time-domain audio signal.
Example 57 provides the apparatus of example 56, where each of the plurality of AI models share the shared feature decoder, and where the shared feature decoder is used after processing by the plurality of AI models.
Example 58 provides the apparatus of example 56 or 57, where processing the feature-domain representation through the plurality of AI models includes generating intermediate mask-processed data based on a feature mask generated by an upstream AI model and processing, by a downstream AI model, at least one of the feature-domain representation and the intermediate mask-processed data to generate a subsequent feature mask.
Example 59 provides the apparatus of any one of examples 56-58, where the second mask-processed data includes updated mask information generated based on the feature masks, and where the operations include applying the updated mask information to the feature-domain representation after processing by the plurality of AI models.
Example 60 provides the apparatus of any one of examples 56-59, where the operations further include transmitting between processing modules expanded audio-frame information including time-domain PCM samples, feature-domain samples, and feature-mask data, where the time-domain PCM samples, the feature-domain samples, and the feature-mask data are stored in a three-element buffer.
Example 61 provides the apparatus of example 60, where the three-element buffer is implemented as a queue including pointers to consecutive in-memory representations of each of the time-domain PCM samples, the feature-domain samples, and the feature-mask data.
Example 62 provides the apparatus of any one of examples 56-61, the plurality of AI models includes an AI model deployed in an endpoint effect (EFX) module and an AI model deployed in a mode effect (MFX) module, where the EFX module applies processing to a plurality of audio streams visible to an operating system and the MFX module applies stream-specific processing to a selected audio stream of the plurality of audio streams.
Example 63 provides the apparatus of any one of examples 56-62, different AI models of the plurality of AI models perform different audio processing operations, and where the different audio processing operations include at least two of echo reduction, echo cancellation, noise reduction, automatic gain control, dereverberation, speech enhancement, and audio enhancement.
Example 64 provides the apparatus of any one of examples 56-63, where the plurality of AI models includes at least three AI models, and where a downstream AI model of the at least three AI models processes at least one of the feature-domain representation, intermediate mask-processed data, and data modified using a generated feature mask to generate a corresponding feature mask.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

What is claimed is:

1. An apparatus, comprising:
a computer processor for executing computer program instructions; and
a non-transitory computer-readable memory storing computer program instructions executable by the computer processor to perform operations comprising:
encoding, by a shared feature encoder, a time-domain audio signal into a feature-domain representation;
processing the feature-domain representation through a plurality of artificial intelligence (AI) models, each generating a feature mask, wherein the plurality of AI models are sequentially arranged;
generating mask-processed data based on the feature masks; and
decoding, at a shared feature decoder, the mask-processed data into a processed time-domain audio signal.

2. The apparatus of claim 1, wherein each of the plurality of AI models share the shared feature decoder, and wherein the shared feature decoder is used after processing by the plurality of AI models.

3. The apparatus of claim 1, wherein processing the feature-domain representation through the plurality of AI models comprises generating intermediate mask-processed data based on a feature mask generated by an upstream AI model and processing, by a downstream AI model, at least one of the feature-domain representation and the intermediate mask-processed data to generate a subsequent feature mask.

4. The apparatus of claim 1, wherein the mask-processed data comprises updated mask information generated based on the feature masks, and wherein the operations comprise applying the updated mask information to the feature-domain representation after processing by the plurality of AI models.

5. The apparatus of claim 1, wherein the operations further comprise transmitting between processing modules expanded audio-frame information comprising time-domain PCM samples, feature-domain samples, and feature-mask data, wherein the time-domain PCM samples, the feature-domain samples, and the feature-mask data are stored in a three-element buffer.

6. The apparatus of claim 5, wherein the three-element buffer is implemented as a queue comprising pointers to consecutive in-memory representations of each of the time-domain PCM samples, the feature-domain samples, and the feature-mask data.

7. The apparatus of claim 1, wherein the plurality of AI models includes an AI model deployed in an endpoint effect (EFX) module and an AI model deployed in a mode effect (MFX) module, wherein the EFX module applies processing to a plurality of audio streams visible to an operating system and the MFX module applies stream-specific processing to a selected audio stream of the plurality of audio streams.

8. The apparatus of claim 1, wherein different AI models of the plurality of AI models perform different audio processing operations, and wherein the different audio processing operations include at least two of echo reduction, echo cancellation, noise reduction, automatic gain control, dereverberation, speech enhancement, and audio enhancement.

9. The apparatus of claim 1, wherein the plurality of AI models comprises at least three AI models, and wherein a downstream AI model of the at least three AI models processes at least one of the feature-domain representation, intermediate mask-processed data, and data modified using a generated feature mask to generate a corresponding feature mask.

10. One or more non-transitory computer-readable media storing instructions executable to perform operations, the operations comprising:
encoding, by a shared feature encoder, a time-domain audio signal into a feature-domain representation;
processing the feature-domain representation through a plurality of artificial intelligence (AI) models, each generating a feature mask, wherein the plurality of AI models are sequentially arranged;
generating mask-processed data based on the feature masks; and
decoding, at a shared feature decoder, the mask-processed data into a processed time-domain audio signal.

11. The one or more non-transitory computer-readable media of claim 10, the operations further comprising processing at least one of the feature-domain representation, mask-processed data, and data modified using one or more of the feature masks using an additional AI model of the plurality of AI models to generate an additional feature mask.

12. The one or more non-transitory computer-readable media of claim 10, wherein the mask-processed data comprises an updated feature mask generated based on the feature masks generated by the plurality of AI models, and wherein the operations comprise applying the updated feature mask to the feature-domain representation after processing by the plurality of AI models.

13. The one or more non-transitory computer-readable media of claim 10, the operations further comprising transmitting between processing modules time-domain PCM samples, feature-domain samples, and feature-mask data, wherein the time-domain PCM samples, the feature-domain samples, and the feature-mask data are stored in a three-element buffer.

14. The one or more non-transitory computer-readable media of claim 13, wherein the three-element buffer is implemented as a queue including pointers to consecutive in-memory representations of each of the time-domain PCM samples, the feature-domain samples, and the feature-mask data.

15. The one or more non-transitory computer-readable media of claim 10, wherein at least one AI model of the plurality of AI models is deployed in an endpoint effect (EFX) module and at least one other AI model of the plurality of AI models is deployed in a mode effect (MFX) module.

16. The one or more non-transitory computer-readable media of claim 15, wherein the EFX module applies processing to a plurality of audio streams visible to an operating system and the MFX module applies stream-specific processing to a selected audio stream of the plurality of audio streams.

17. The one or more non-transitory computer-readable media of claim 10, wherein different AI models of the plurality of AI models perform different audio processing operations, and wherein the different audio processing operations include two or more of echo reduction, echo cancellation, noise reduction, automatic gain control, dereverberation, speech enhancement, and audio enhancement.

18. The one or more non-transitory computer-readable media of claim 10, wherein the operations further comprise processing at least one of the feature-domain representation and intermediate mask-processed data using a downstream AI model of the plurality of AI models to generate a corresponding feature mask, wherein the plurality of AI models share the shared feature encoder and the shared feature decoder.

19. A computer-implemented method, comprising:
encoding, by a shared feature encoder, a time-domain audio signal into a feature-domain representation;
processing the feature-domain representation through a plurality of artificial intelligence (AI) models, each generating a feature mask, wherein the plurality of AI models are sequentially arranged;
generating mask-processed data based on the feature masks; and
decoding, at a shared feature decoder, the mask-processed data into a processed time-domain audio signal.

20. The computer-implemented method of claim 19, wherein processing the feature-domain representation through the plurality of AI models includes generating intermediate mask-processed data based on a feature mask generated by an upstream AI model and processing, by a downstream AI model, at least one of the feature-domain representation and the intermediate mask-processed data to generate a subsequent feature mask.
